(19) United States
(12) Patent Application Publication
(10) Pub. No.: US 2013/0063713 A1
(43) Pub. Date: Mar. 14, 2013

(54) Vehicle Provided with a Device for Detecting External Laser Measuring Equipment and Method for Mounting Such a Device

(71) Applicants: Tom Marnix Alexander De Wilde, Hillegom (NL); Patrick Dijkstra, Driebruggen (NL)

(72) Inventors: Tom Marnix Alexander De Wilde, Hillegom (NL); Patrick Dijkstra, Driebruggen (NL)

(73) Assignee: Stichting Noble House, Hillegom (NL)

(21) Appl. No.: 13/576,721

(22) PCT Filed: Feb. 3, 2011
(86) PCT No.: PCT/NL2011/050073

§ 371 Date: Nov. 20, 2012

(30) Foreign Application Priority Data
Feb. 5, 2010 (NL) 2004199

(51) Int. Cl. G01P 3/36; B23P 11/00

(52) U.S. Cl. 356/28; 29/428

(57) ABSTRACT

Disclosed is a vehicle provided with at least one detector designed to detect external measuring equipment that emits laser pulses for detecting or measuring the speed of the vehicle. The vehicle is further provided with at least one glass fibre cable whose first end is fixed in front of the detector, facing said detector, and with a transparent receiving element connected to the glass fibre cable for receiving the laser pulses and passing said pulses on to the glass fibre cable. The receiving element is attached to the exterior of the vehicle and, in stretched condition, extends along a length of at least 0.25 m on the vehicle surface.

The present invention relates to a vehicle provided with at least one detector designed to detect external measuring equipment that emits laser pulses for detecting or measuring the speed of the vehicle, which vehicle is further provided with at least one glass fibre cable whose first end is fixed in front of the detector, facing said detector.

The object of the invention is to provide means by which a better, quicker and more reliable detection of laser pulses emitted by external measuring equipment can be realised.

According to the invention, the vehicle to that end comprises a transparent receiving element connected to the glass fibre cable for receiving the laser pulses and passing said pulses on to the glass fibre cable, which receiving element is attached to the exterior of the vehicle and which, in stretched condition, extends along a length of at least 0.25 on the vehicle surface. An advantage of such a transparent receiving element is that the detectors themselves can be mounted within the vehicle, whilst laser pulses can be efficiently received by the receiving element. As a result, the detectors are not exposed to external influences, which influences may be harmful to the detectors. Another advantage of such a receiving element is that such receiving elements are capable of receiving laser pulses over the entire external surface thereof, thereby increasing the chance that laser pulses emitted by external measuring equipment will be received and will reach the detector. Thus, a vehicle is provided which is capable of detecting laser pulses emitted by external measuring equipment in a reliable and/or efficient and/or adequate manner.

In one embodiment of a vehicle according to the invention, the receiving element comprises a part of the glass fibre cable in stretched condition. In particular at least that part of the glass fibre caber is of the “side illuminating” or “side sensitive” type, which implies that light from outside can easily enter from the side. Said part of the glass fibre cable can be easily attached to the exterior of the vehicle, being capable of efficiently receiving laser pulses both through the circumference of the cable and through the end. Preferably, said part of the glass fibre cable has a length of at least 0.5 m, more preferably at least 1.0 m, even more preferably 1.5 m. The greater the length of said part of the glass fibre cable, the greater the chance that laser pulses will be received by said part. Preferably, said part of the glass fibre cable extends at least substantially around the entire circumference of the vehicle for receiving laser pulses from several sectors around the vehicle. In this way the chance that the laser pulses will be received is further increased, because it does not matter from which sector the laser pulses are emitted.

In another embodiment of the vehicle according to the invention, the receiving element comprises a transparent plate. Such a transparent plate has a proportionally large external surface for receiving laser pulses, so that there is a greater chance that the laser pulses will be detected by the vehicle.

In another embodiment of the vehicle according to the invention, the receiving element comprises a transparent coating. Such a coating has the advantage that it can be easily applied to a large part of the external surface of the vehicle, more in particular, the entire external surface of the vehicle may be provided with such a coating. This further increases the chance that the laser pulses will be detected by the vehicle.

In another embodiment of the vehicle according to the invention, the vehicle is provided with several receiving elements, each receiving element being connected to the glass fibre cable, which receiving elements are attached to the exterior of the vehicle in several areas for receiving laser pulses from several sectors around the vehicle. An advantage of using several receiving elements is that this makes it possible to determine from which sector the laser pulses were received, which can provide information as to the location of the measuring equipment. The vehicle is preferably provided with several detectors, to each of which detectors a glass fibre cable is connected. Preferably, the detector is mounted in a central housing in the vehicle. The central housing can thus be easily mounted in the vehicle, after which only the glass fibre cables and/or the receiving elements need to be installed and/or mounted.

In another embodiment of a vehicle according to the invention, the glass fibre cable comprises several parallel glass fibres. Because of this, the glass fibre cable is relatively flexible, making it possible to use a smaller bend radius of the cable. Furthermore, the cable can thus be more easily attached to the exterior of the vehicle.

In another embodiment of the vehicle according to the invention, the glass fibre cable has a cross-sectional area of 0.1-20 mm², preferably 0.4-10 mm², more preferably 0.5-2 mm².

The invention also relates to a method for mounting at least one detector inside a vehicle, which detector is designed to detect external measuring equipment that emits laser pulses for detecting or measuring the speed of an object, such as a vehicle, which method further comprises fixing an end of at least one glass fibre cable in front of the detector, facing said detector, and mounting a transparent receiving element that is connected to the glass fibre cable to the exterior of the vehicle for receiving the laser pulses and passing said pulses to the glass fibre cable, such that the receiving element extends along a length of at least 0.25 m on the surface of the vehicle.

The invention will now be explained in more detail with reference to figures illustrated in a drawing, in which:

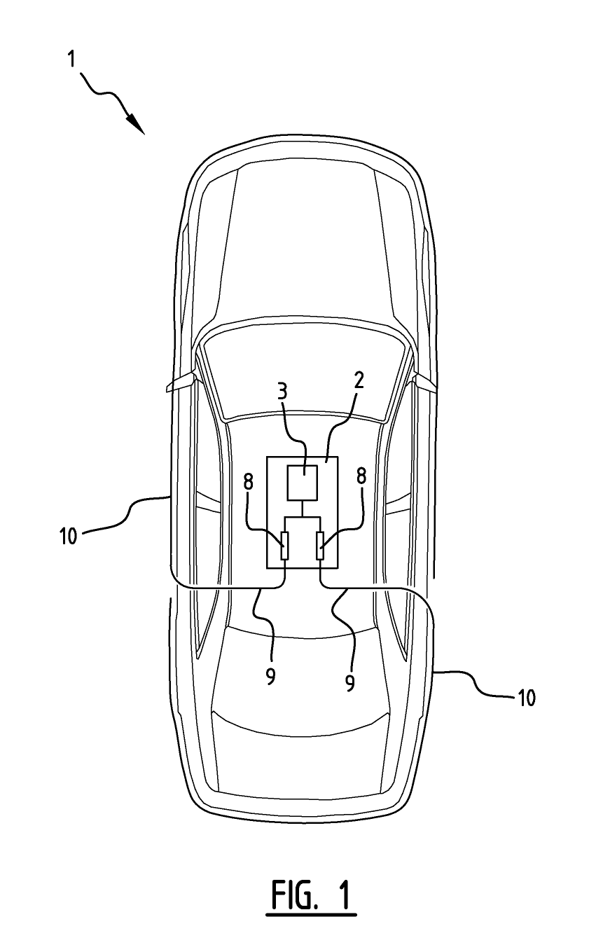

FIG. 1 is a top plan view of a vehicle according to the invention;

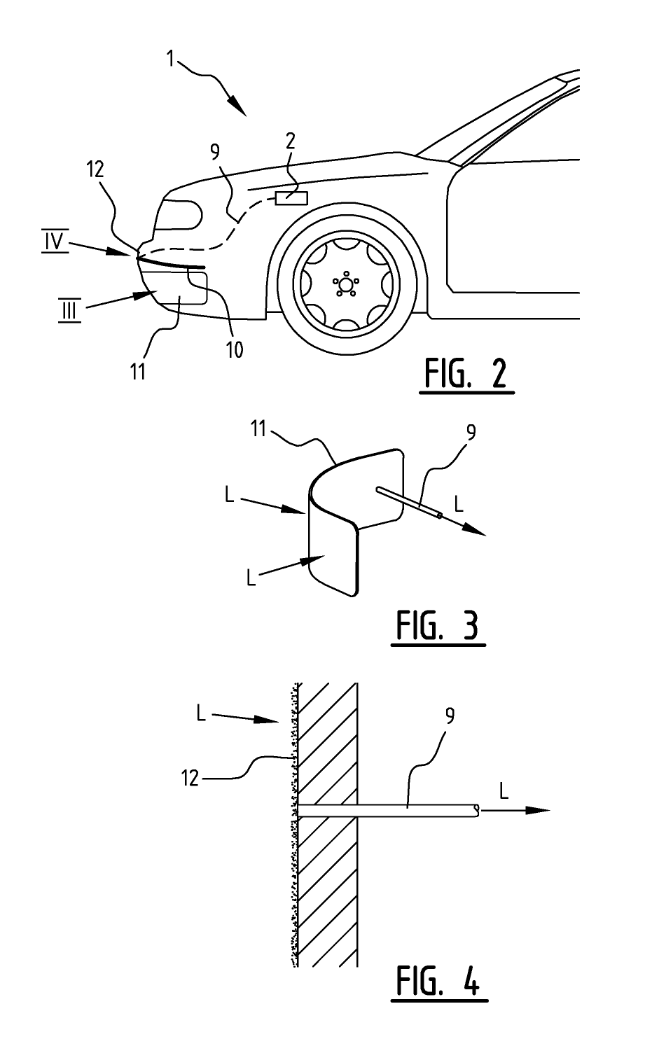

FIG. 2 is a side view of a vehicle according to another embodiment of the invention;

FIG. 3 is a detail view of a receiving element according to one embodiment of the invention; and

FIG. 4 is a side view of a receiving element according to another embodiment of the invention.

In FIG. 1 a vehicle 1 is schematically shown. The vehicle 1 is provided with a housing 2 with a central processing unit 3. The central processing unit 3 is connected to two laser detectors 8, which are capable of detecting the laser signal from an external laser speed measuring device.

The laser detectors 8 are disposed in the housing 2 at a central location in the vehicle 1. A glass fibre cable 9 is attached to the detection surface of each detector 8, such that laser pulses being transported through the glass fibre cable 9 and exiting the end of the glass fibre cable can be incident on the detector 8. The glass fibre cables 9 each consist of a bundle of glass fibres having a total cross-sectional area of about 1 mm².

Apart 10 of each glass fibre cable 9 is attached to the exterior of the vehicle, which parts 10 of the glass fibre cables 9 are capable of receiving laser pulses from external measuring equipment. The parts 10 thus form a transparent receiving element. Said parts of the glass fibre cable are of the “side illuminating” or “side sensitive” type, so that a laser beam can readily enter the glass fibre cable. The parts 10 of the glass fibre cables 9 are mounted at different areas of the vehicle 1, such that they are directed toward two different sectors, so that laser pulses from external laser equipment from said two sectors can be incident on the parts 10. In particular, the parts 10 are attached to the front and the rear side of the vehicle. The length of the parts pin is at least 0.25 m, preferably more than 0.5 m, even more preferably 0.5 m. Because of said length, there is a good chance that the laser pulses will be received by the parts 10.

FIG. 2 shows a vehicle 1 comprising several examples of receiving elements. A glass fibre cable part 10 as described above is attached to the front bumper of the vehicle. The vehicle is further provided with a plate-shaped, transparent receiving element 11, which plate-shaped transparent receiving element 11 is connected to a glass fibre cables 9 (see also FIG. 3). The vehicle 1 may also be provided with a transparent coating 12 (see FIG. 4), which coating 12 is connected to a glass fibre cable 9. Connecting several glass fibre cables 9, which are each connected to a detector 8, to the coating 12 enables the central processing unit 3 to determine from which sector of the vehicle the laser pulses were received, since the period of time between receiving a laser pulse and the arrival of said polls at the detector depends on the distance between the reception point and the glass fibre cable. According to another possibility, only the first signal received by a detector 8 is processed, in which case it is clear to which glass fibre cables 9 said detector is connected and information is thus provided regarding the sector from which the laser pulses emanate, since the glass fibre cable 9 that is located nearest the reception point will transport the signal the most quickly to the detector 8. The further away the glass fibre cables 9 are located from the reception point, the weaker the signal will be, so that there is a possibility that no signal will be processed at a number of glass fibre cables 9 and detectors 8. Use is possibly made of this fact, since the inability of a detector to process a signal can provide information regarding the sector from which the laser pulses emanate.

It is noted that the invention is not limited to the above-discussed embodiment, but that it also extends to other variants that fall within the scope of the appended claims.

1. A vehicle provided with at least one detector designed to detect external measuring equipment that emits laser pulses for detecting or measuring the speed of the vehicle, which vehicle is further provided with at least one glass fibre cable whose first end is fixed in front of the detector, facing said detector, and with a transparent receiving element connected to the glass fibre cable for receiving the laser pulses and passing said pulses on to the glass fibre cable, which receiving element is attached to the exterior of the vehicle and which, in stretched condition, extends along a length of at least 0.25 in on the vehicle surface.

2. The vehicle according to claim 1, wherein the receiving element comprises a part of the glass fibre cable in stretched condition, which part is preferably of the side illuminating or side sensitive type.

3. The vehicle according to claim 2, wherein said part of the glass fibre cable has a length of at least 0.5 m, more preferably at least 1.0 m, even more preferably 1.5 m.

4. The vehicle according to claim 2, wherein said part of the glass fibre cable extends at least substantially around the entire circumference of the vehicle for receiving laser pulses from several sectors around the vehicle.

5. The vehicle according to claim 1, wherein the receiving element comprises a transparent plate.

6. The vehicle according to claim 1, wherein the receiving element comprises a transparent coating.

7. The vehicle according to claim 1, wherein the vehicle is provided with several receiving elements, each receiving element being connected to the glass fibre cable, which receiving elements are attached to the exterior of the vehicle in several areas for receiving laser pulses from several sectors around the vehicle.

8. The vehicle according to claim 7, wherein the vehicle is preferably provided with several detectors, to each of which detectors a glass fibre cable is connected.

9. The vehicle according to claim 1, wherein the detector is mounted in a central housing in the vehicle.

10. The vehicle according to claim 1, wherein the glass fibre cable comprises several parallel glass fibres.

11. The vehicle according to claim 1, wherein the glass fibre cable has a cross-sectional area of 0.1-20 mm², preferably 0.4-10 mm², more preferably 0.5-2 mm².

12. A method for mounting at least one detector inside a vehicle, which detector is designed to detect external measuring equipment that emits laser pulses for detecting or measuring the speed of an object, such as a vehicle, which method further comprises fixing an end of at least one glass fibre cable in front of the detector, facing said detector, and mounting a transparent receiving element that is connected to the glass fibre cable to the exterior of the vehicle for receiving the laser pulses and passing said pulses to the glass fibre cable, such that the receiving element extends along a length of at least 0.25 m on the surface of the vehicle.

13. The method according to claim 12, wherein the receiving element comprises a part of the glass fibre cable, and wherein the method comprises attaching said part of the glass fibre cable to the exterior of the vehicle.

14. The method according to claim 13, wherein the part of the glass fibre cable that is attached to the exterior has a length of at least 0.5 m, more preferably at least 1.0 m, even more preferably 1.5 m.

15. The method according to claim 13, wherein the receiving element comprises a transparent coating, wherein the method comprises the application of a coating to the exterior of the vehicle.

16. The method according to claim 14, wherein the receiving element comprises a transparent coating, wherein the method comprises the application of a coating to the exterior of the vehicle.

17. The vehicle according to claim 3, wherein said part of the glass fibre cable extends at least substantially around the entire circumference of the vehicle for receiving laser pulses from several sectors around the vehicle.

18. The vehicle according to claim 2, wherein the vehicle is provided with several receiving elements, each receiving element being connected to the glass fibre cable, which receiving elements are attached to the exterior of the vehicle in several areas for receiving laser pulses from several sectors around the vehicle.

19. The vehicle according to claim 3, wherein the vehicle is provided with several receiving elements, each receiving element being connected to the glass fibre cable, which receiving elements are attached to the exterior of the vehicle in several areas for receiving laser pulses from several sectors around the vehicle.

20. The vehicle according to claim 4, wherein the vehicle is provided with several receiving elements, each receiving element being connected to the glass fibre cable, which receiving elements are attached to the exterior of the vehicle in several areas for receiving laser pulses from several sectors around the vehicle.
